(19) United States
(12) Patent Application Publication
(10) Pub. No.: US 2013/0074810 A1
(43) Pub. Date: Mar. 28, 2013

(54) COMBUSTION PRESSURE CONTROL DEVICE

(71) Applicant: Takeshi Ashizawa, Yokohama-shi (JP)

(72) Inventor: Takeshi Ashizawa, Yokohama-shi (JP)

(73) Assignee: TOYOTA JIDOSHA KABUSHIKI KAISHA, Toyota-shi (JP)

(21) Appl. No.: 13/521,473

(22) PCT Filed: Feb. 25, 2010
(86) PCT No.: PCT/JP2010/053484

§ 371 Date: Jul. 11, 2012

(51) Int. Cl. F02B 75/38

(52) U.S. Cl. CPC F02B 75/38
USPC 123/48 D

(57) ABSTRACT

A combustion pressure control system of an internal combustion engine which has sub chambers which are communicated with combustion chambers, provided with spring devices each of which has elasticity and which has one side connected to a sub chamber which is communicated with one combustion chamber and has the other side connected to a sub chamber which is communicated with the other combustion chamber. The spring device includes a fluid sealing member. When at least one of the one combustion chamber and the other combustion chamber reaches a control pressure in the time period from a compression stroke to expansion stroke of the combustion cycle, the spring device contracts, whereby the volumes of the sub chambers increase and the pressure rise of the combustion chambers is suppressed.

### TECHNICAL FIELD

The present invention relates to a combustion pressure control system.

### BACKGROUND ART

An internal combustion engine comprises a combustion chamber with fuel and air and burns the fuel in the combustion chamber to output a drive force. When burning the fuel in the combustion chamber, the mixture of the air and fuel is compressed in state. It is known that the compression ratio of an internal combustion engine has an effect on the output and fuel consumption. By raising the compression ratio, the output torque can be made larger and the fuel consumption can be reduced.

Japanese Patent Publication (A) No. 2000-230439 discloses a self-ignition type of internal combustion engine which provides a sub chamber communicated with a combustion chamber through a pressure regulating valve and configures the pressure regulating valve by a valve element and a stem which is connected to the valve element and is biased to the combustion chamber side. This self-ignition type of internal combustion engine is disclosed to push up the pressure regulating valve against the pressure of an elastic body so as to release pressure to the sub chamber when excessively early ignition etc. causes the combustion pressure to exceed a predetermined allowable pressure. This publication discloses the pressure regulating valve operating by a pressure larger than the pressure generated by excessively early ignition etc.

Japanese Patent Publication (A) No. 2002-317702 discloses an in-line multicylinder internal combustion engine designed to take out part of the combustion gas at the time of a first half of an explosive stroke in one cylinder at a high load region and introduce this to one cylinder among the other cylinders in the middle of an intake stroke or compression stroke. This internal combustion engine is disclosed as inhibiting the occurrence of knocking and other abnormal phenomenon in a high load region when setting the compression ratios at the cylinders at high values.

### CITATIONS LIST

### Patent Literature

PLT 1: Japanese Patent Publication (A) No. 2000-230439

PLT 2: Japanese Patent Publication (A) No. 2002-317702

### SUMMARY OF INVENTION

### Technical Problem

In a spark ignition type of internal combustion engine, a mixture of fuel and air in a combustion chamber is ignited by an ignition device, whereby the air-fuel mixture burns and the piston is pushed down. At this time, the compression ratio is raised to improve the thermal efficiency. In this regard, if the compression ratio is raised, abnormal combustion sometimes occurs. For example, by raising the compression ratio, the self-ignition phenomenon sometimes occurs.

To prevent the occurrence of abnormal combustion, it is possible to retard the ignition timing. However, by retarding the ignition timing, the output torque becomes smaller and the fuel consumption deteriorates. Further, by retarding the ignition timing, the temperature of the exhaust gas becomes higher. For this reason, high quality materials become necessary for the component parts of the exhaust purification system and a system for cooling the exhaust gas sometimes becomes necessary. Furthermore, to lower the temperature of the exhaust gas, sometimes the air-fuel ratio when burning fuel in the combustion chamber is made less than the stoichiometric air-fuel ratio. That is, sometimes the air-fuel ratio at the time of combustion is made rich. However, when a three-way catalyst is arranged as the exhaust purification system, if the air-fuel ratio of the exhaust gas deviates from the stoichiometric air-fuel ratio, there is the problem that the purification ability ends up becoming smaller and the exhaust gas can no longer be sufficiently purified.

In the internal combustion engine which is disclosed in the above Japanese Patent Publication (A) No. 2000-230439, a space which is communicated with a combustion chamber is formed at the cylinder head and a mechanical spring is arranged in this space. However, in this internal combustion engine, one mechanical spring is arranged for one combustion chamber so there was the problem that the structure becomes complicated. Further, when arranging a mechanical spring at the cylinder head, it is not possible to increase the size of the mechanical spring and it is liable to not be possible to obtain a sufficient pushing force.

The present invention has as its object the provision of a combustion pressure control system which suppresses abnormal combustion and is simple in configuration.

### Solution to Problem

The combustion pressure control system of the present invention is a combustion pressure control system of an internal combustion engine which has a plurality of combustion chambers and sub chambers which are communicated with those combustion chambers, which system is provided with spring devices each of which has elasticity and which has one side connected to a sub chamber which is communicated with one combustion chamber and has the other side connected to a sub chamber which is communicated with the other combustion chamber. The spring device is formed so as to contract while using a pressure change of the combustion chambers as a drive source when the pressures of combustion chambers reach a predetermined control pressure. When at least one of the one combustion chamber and the other combustion chamber reaches the control pressure in the time period from a compression stroke to expansion stroke of the combustion cycle, the spring device contracts, whereby the volumes of the sub chambers increase and the pressure rise of the combustion chambers is suppressed.

In the above invention, preferably in the time period where the pressure of the one combustion chamber which is connected to the spring device reaches the control pressure, the pressure of the other combustion chamber is less than the control pressure.

In the above invention, preferably when the one combustion chamber which is connected to the spring device is in the compression stroke, the other combustion chamber is in an intake stroke or an exhaust stroke.

In the above invention, the spring device may include a fluid spring which is filled inside it with a compressible fluid.

In the above invention, the system can be provided with an operating state detecting device which detects an operating state of the internal combustion engine, a fluid storage part which is connected to an inside space of the fluid spring and stores fluid, and a volume adjusting device which changes a volume of the fluid storage part, can detect the operating state of the internal combustion engine, can select a maximum pressure of the combustion chambers in accordance with the detected operating state, and can use the selected maximum pressure of the combustion chambers as the basis to change a volume of the fluid storage part.

In the above invention, the volume adjusting device can increase the volume of the fluid storage part the lower the maximum pressure of the combustion chambers selected in accordance with the operating state.

In the above invention, the system can be provided with an operating state detecting device which detects an operating state of the internal combustion engine and a connecting device which connects the inside spaces of a plurality of fluid springs, can detect the operating state of the internal combustion engine, can select a maximum pressure of the combustion chambers in accordance with the detected operating state, and can use the selected maximum pressure of the combustion chambers as the basis to change the number of the fluid springs which are connected to each other.

In the above invention, the connecting device can increase the number of fluid springs which are connected to each other the lower the selected maximum pressure of the combustion chambers.

In the above invention, preferably the spring device includes one moving member which is arranged at the one combustion chamber side, the other moving member which is arranged at the other combustion chamber side, stopping parts each of which limits movement of a moving member toward a combustion chamber, and sealing members each which is arranged at the surface of at least one of a stopping part and a moving member for sealing the fluid, the sealing member being interposed between the moving member and the stopping part when the moving member reaches the stopping part and stops.

In the above invention, preferably the spring device includes one moving member which is arranged at the one combustion chamber side, the other moving member which is arranged at the other combustion chamber side, and stopping parts each of which limits movement of a moving member toward a combustion chamber, the stopping part has a concave-convex portion which is formed in a region facing a moving member, the moving member has a concave-convex portion which is formed in a region facing the stopping part, and the concave-convex portion which is formed at the stopping part and the concave-convex portion which is formed at the moving member fit with and closely contact each other when the moving member reaches the stopping part and stops.

### Advantageous Effects of Invention

According to the present invention, it is possible to provide a combustion pressure control system which suppresses abnormal combustion and is simple in configuration.

### BRIEF DESCRIPTION OF DRAWINGS

FIG. 1 is a schematic view of an internal combustion engine in an Embodiment 1.

FIG. 2 is a schematic cross-sectional view of an internal combustion engine which is provided with a first combustion pressure control system in an Embodiment 1.

FIG. 3 is a schematic cross-sectional view of a spring device of a first combustion pressure control system in the Embodiment 1.

FIG. 4 is a view which explains pressures of combustion chambers and an amount of contraction of a fluid spring in a combustion pressure control system in the Embodiment 1.

FIG. 5 is a graph which explains the relationship between an ignition timing and output torque in an internal combustion engine of a comparative example.

FIG. 6 is a graph which explains the relationship between a crank angle and pressures of combustion chambers in an internal combustion engine of a comparative example.

FIG. 7 is a graph which explains a relationship between a load and a maximum pressure of the combustion chambers in an internal combustion engine of a comparative example.

FIG. 8 is an enlarged view of a graph for when pressures of combustion chambers reach a control pressure in an internal combustion engine which is provided with a combustion pressure control system of the Embodiment 1.

FIG. 9 is a graph which explains an ignition timing of an internal combustion engine in the Embodiment 1 and an internal combustion engine of a comparative example.

FIG. 10 is a schematic view which explains a combustion cycle of a four-cylinder internal combustion engine.

FIG. 11 is a schematic cross-sectional view of a spring device of a second combustion pressure control system in the Embodiment 1.

FIG. 12 is an enlarged cross-sectional view of a spring device of a third combustion pressure control system in the Embodiment 1.

FIG. 13 is a schematic view of an internal combustion engine which is provided with a fourth combustion pressure control system in the Embodiment 1.

FIG. 14 is a schematic cross-sectional view of an internal combustion engine which is provided with a first combustion pressure control system in the Embodiment 2.

FIG. 15 is an enlarged cross-sectional view of a spring device of a first combustion pressure control system in an Embodiment 2.

FIG. 16 is a graph which explains the relationship between the speed of an internal combustion engine and a knocking margin ignition timing in a comparative example.

FIG. 17 is a graph which explains the relationship between the speed of an internal combustion engine and a maximum pressure of the combustion chambers in an embodiment 2.

FIG. 18 is a graph which explains a relationship between a concentration of alcohol which is contained in fuel and a retardation correction amount in a comparative example.

FIG. 19 is a graph which explains a relationship between a concentration of alcohol and a maximum pressure of the combustion chambers in the Embodiment 2.

FIG. 20 is a schematic cross-sectional view of an internal combustion engine which is provided with a second combustion pressure control system in an Embodiment 2.

FIG. 21 is a schematic cross-sectional view of an internal combustion engine which is provided with a first combustion pressure control system in the Embodiment 3.

FIG. 22 is a schematic cross-sectional view of an internal combustion engine which is provided with a second combustion pressure control system in the Embodiment 3.

### DESCRIPTION OF EMBODIMENTS

### Embodiment 1

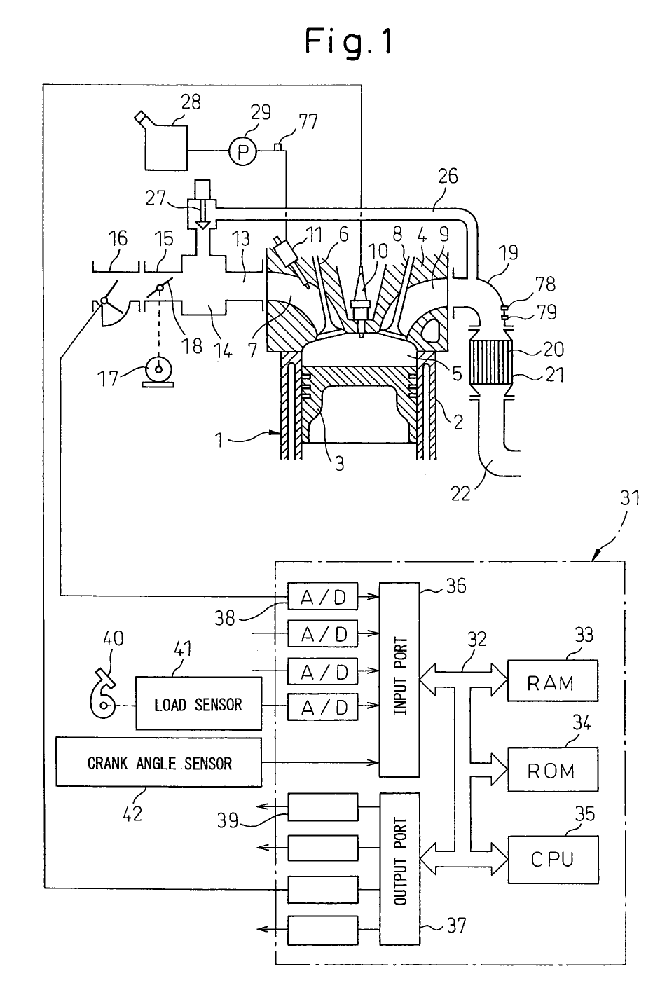

Referring to FIG. 1 to FIG. 13, a combustion pressure control system of an internal combustion engine in an Embodiment 1 will be explained. In the present embodiment, an internal combustion engine which is arranged in a vehicle will be explained as an example.

FIG. 1 is a schematic view of an internal combustion engine in the present embodiment. The internal combustion engine in the present embodiment is a spark ignition type. The internal combustion engine is provided with an engine body 1. The engine body 1 includes a cylinder block 2 and a cylinder head 4. At the inside of the cylinder block 2, pistons 3 are arranged. Each piston 3 moves in a reciprocating manner inside of the cylinder block 2. In the present invention, the space which is surrounded by a crown surface of the piston and the cylinder head when the piston reaches compression top dead center and the space inside of a cylinder which is surrounded by the crown surface of the piston at any position and the cylinder head is called a “combustion chamber”. A combustion chamber 5 is formed for each cylinder. Each combustion chamber 5 is connected to an engine intake passage and an engine exhaust passage. The engine intake passage is a passage for feeding the combustion chamber 5 with air or a mixture of fuel and air. The engine exhaust passage is a passage for exhausting exhaust gas generated by combustion of fuel inside of the combustion chamber 5.

The cylinder head 4 is formed with intake ports 7 and exhaust ports 9. An intake valve 6 is arranged at an end part of each intake port 7 and is formed to be able to open and close the engine intake passage communicated with each combustion chamber 5. An exhaust valve 8 is arranged at an end part of each exhaust port 9 and is formed to be able to open and close the engine exhaust passage communicated with each combustion chamber 5. The cylinder head 4 has spark plugs 10 fastened to it as ignition devices. Each spark plug 10 is formed so as to ignite fuel in each combustion chamber 5.

The internal combustion engine in the present embodiment is provided with fuel injectors 11 for feeding fuel to the combustion chambers 5. Each fuel injector 11 in the present embodiment is arranged so as to inject fuel into an intake port 7. The fuel injector 11 is not limited to this. It is sufficient that it be arranged so as to be able to feed fuel into the combustion chamber 5. For example, the fuel injector may also be arranged to directly inject fuel into the combustion chamber.

Each fuel injector 11 is connected through an electronically controlled variable discharge fuel pump 29 to a fuel tank 28. Fuel which is stored inside of the fuel tank 28 is fed by the fuel pump 29 to the fuel injector 11. In the middle of the channel which feeds the fuel, a fuel property sensor 77 is arranged as a fuel property detecting device which detects a property of the fuel. For example, in an internal combustion engine which uses a fuel which contains alcohol, an alcohol concentration sensor is arranged as the fuel property sensor 77. The fuel property detecting device may also be arranged at the fuel tank.

The intake port 7 of each cylinder is connected through a corresponding intake runner 13 to a surge tank 14. The surge tank 14 is connected through an intake duct 15 and an air flow meter 16 to an air cleaner (not shown). Inside the intake duct 15, an air flow meter 16 is arranged which detects the intake air amount. Inside of the intake duct 15, a throttle valve 18 is arranged which is driven by a step motor 17. On the other hand, the exhaust port 9 of each cylinder is connected to a corresponding exhaust runner 19. The exhaust runner 19 is connected to a catalytic converter 21. The catalytic converter 21 in the present embodiment includes a three-way catalyst 20. The catalytic converter 21 is connected to an exhaust pipe 22. Inside the engine exhaust passage, a temperature sensor 78 is arranged for detecting the temperature of the exhaust gas.

The engine body 1 in the present embodiment has a recirculation passage for performing exhaust gas recirculation (EGR). In the present embodiment, an EGR gas conduit 26 is arranged as a recirculation passage. The EGR gas conduit 26 connects the exhaust runners 19 and the surge tank 14 with each other. Inside the EGR gas conduit 26, an EGR control valve 27 is arranged. The EGR control valve 27 is formed to be adjustable in flow rate of the recirculating exhaust gas. If the ratio of the air and fuel (hydrocarbons) of the exhaust gas which is supplied to the engine intake passage, combustion chamber, or engine exhaust passage is referred to as the air-fuel ratio (A/F) of the exhaust gas, an air-fuel ratio sensor 79 is arranged at the upstream side of the catalytic converter 21 inside the engine exhaust passage for detecting the air-fuel ratio of the exhaust gas.

The internal combustion engine in the present embodiment is provided with an electronic control unit 31. The electronic control unit 31 in the present embodiment is comprised of a digital computer. The electronic control unit 31 includes components which are connected with each other through a bidirectional bus 32 such as a RAM (random access memory) 33, ROM (read only memory) 34, CPU (microprocessor) 35, input port 36, and output port 37.

The air flow meter 16 generates an output voltage which is proportional to the amount of intake air which is taken into each combustion chamber 5. This output voltage is input through a corresponding AD converter 38 to the input port 36. An accelerator pedal 40 has a load sensor 41 connected to it. The load sensor 41 generates an output voltage which is proportional to an amount of depression of the accelerator pedal 40. This output voltage is input through a corresponding AD converter 38 to the input port 36. Further, a crank angle sensor 42 generates an output pulse every time a crankshaft rotates by, for example, 30°. This output pulse is input to the input port 36. The output of the crank angle sensor 42 may be used to detect the speed of the engine body 1. Furthermore, the electronic control unit 31 receives as input signals of sensors such as the fuel property sensor 77, temperature sensor 78, and air-fuel ratio sensor 79.

The output port 37 of the electronic control unit 31 is connected through respectively corresponding drive circuits 39 to the fuel injectors 11 and the spark plugs 10. In the present embodiment, the electronic control unit 31 is formed to control fuel injection and control ignition. That is, the timing of injection and the amount of injection of fuel are controlled by the electronic control unit 31. Furthermore, the ignition timing of the spark plugs 10 is controlled by the electronic control unit 31. Further, the output port 37 is connected through corresponding drive circuits 39 to the step motor 17 which drives the throttle valve 18, the fuel pump 29, and the EGR control valve 27. These devices are controlled by the electronic control unit 31.

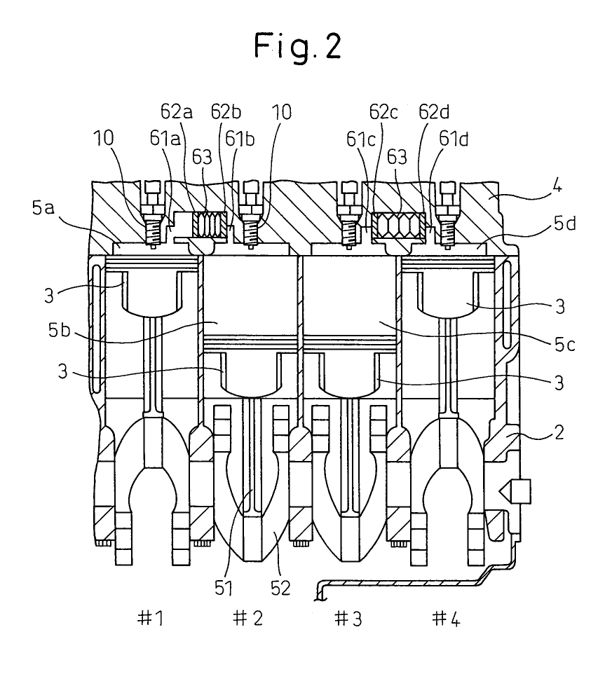

FIG. 2 shows a schematic cross-sectional view of an engine body which is provided with a first combustion pressure control system in the present embodiment. FIG. 2 is a cross-sectional view at the time when cutting the engine body in the direction in which the plurality of cylinders are aligned.

The internal combustion engine which is provided with the first combustion pressure control system has four cylinders. These cylinders are arranged adjoining each other. The respective cylinders are formed with combustion chambers 5a to 5d. The pistons 3 which are arranged at the cylinders are connected to connecting rods 51. The connecting rods 51 are connected to a crankshaft 52. The crankshaft 52 is supported at the cylinder block 2 in a rotatable manner.

The combustion pressure control system in the present embodiment has sub chambers 61a to 61d which communicate with the combustion chambers 5a to 5d. The combustion pressure control system in the present embodiment is provided with volume changing devices which change the volumes of the sub chambers 61a to 61d. The volume changing devices include spring devices which have elasticity.

The first combustion pressure control system includes fluid springs which function as spring devices.

Each fluid spring is formed so as to have elasticity by sealing a compressible fluid inside it. The fluid spring has a sealing mechanism which seals air inside of it. The sealing mechanism of the first combustion pressure control system includes a fluid sealing member 63. The fluid spring is connected at one end to a sub chamber which is communicated with one combustion chamber, while is connected at the other end to a sub chamber which is communicated with the other combustion chamber. A first fluid spring in the present embodiment is connected to the sub chamber 61a which is communicated with the combustion chamber 5a of the first cylinder and the sub chamber 61b which is communicated with the combustion chamber 5b of the second cylinder. Further, a second fluid spring is connected to the sub chamber 61c which is communicated with the combustion chamber 5c of the third cylinder and the sub chamber 61d which is communicated with the combustion chamber 5d of the fourth cylinder.

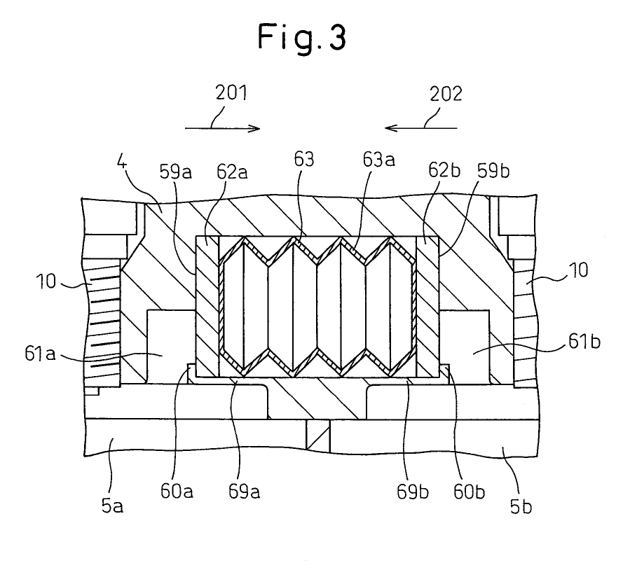

FIG. 3 shows an enlarged schematic cross-sectional view of a spring device in the present embodiment. FIG. 3 is a cross-sectional view of the spring device which is arranged between the first cylinder and the second cylinder. The spring device which is arranged between the third cylinder and the fourth cylinder has a similar configuration.

The fluid sealing member 63 is formed inside it with a space. The fluid sealing member 63 in the present embodiment is formed in a cylindrical outer shape. The fluid sealing member 63 has a bellows part 63a. The fluid sealing member 63 is formed to be able to expand and contract by deformation of the bellows part 63a. The inside of the fluid sealing member 63 has a pressurized fluid sealed inside it. In the present embodiment, air is sealed inside of the fluid sealing member 63.

The fluid spring in the present embodiment has the moving members 62a, 62b. The moving members 62a, 62b are arranged at the both sides of the fluid sealing member 63 in the expansion-contraction direction. The moving members 62a, 62b in the present embodiment are formed in plate shapes. The moving members 62a, 62b are formed to be able to move in the space formed in the cylinder head 4.

The cylinder head 4 has seat parts 69a, 69b for the moving members 62a, 62b. The front ends of the seat parts 69a, 69b have projecting parts 60a, 60b formed on them. The moving members 62a, 62b are limited in movement toward the combustion chambers 5a, 5b by the wall surfaces 59a, 59b of the cavities and the projecting parts 60a, 60b. The wall surfaces 59a, 59b and projecting parts 60a, 60b function as stopping parts which determine the positions at which the moving members 62a, 62b stop. The stopping parts which limit movement of the moving members are not limited to this. Any mechanism which stops movement of the moving members may be employed.

When the pressures at the inside of the combustion chambers 5a, 5b are less than the control pressure, the moving members 62a, 62b contact the wall surfaces 59a, 59b and projecting parts 60a, 60b and stop due to the pressure of the fluid at the inside of the fluid sealing member 63. The fluid sealing member 63 contracts when the pushing force due to the pressures of the combustion chambers becomes larger than the reaction force due to the pressure at the inside of the fluid sealing member 63 in the compression stroke to the expansion stroke of the combustion cycle. The moving members 62a, 62b move in the direction in which the sub chambers 61a, 61b become larger. The volumes of the sub chambers 61a, 61b which are communicated with the combustion chambers 5a, 5b become larger, so it is possible to suppress pressure rises of the combustion chambers 5a, 5b. After that, the fluid sealing member 63 elongates and returns to the original size when the pushing forces due to the pressures of the combustion chambers 5a, 5b becomes smaller than the reaction force due to the pressure inside of the fluid sealing member 63.

For example, when the pressure of the combustion chamber 5a of the first cylinder becomes the control pressure or more, the moving member 62a, as shown by the arrow 201, moves in a direction which compresses the fluid sealing member 63. Further, when the combustion chamber 5b of the second cylinder becomes the control pressure or more, the moving member 62b moves in the direction compressing the fluid sealing member 63 as shown by the arrow 202.

In this way, when the combustion chambers 5a to 5d become the control pressure or more, the moving members 62a to 62d of the fluid springs which are connected to the respective combustion chambers 5a to 5d move, whereby the volumes of the sub chambers 61a to 61d become larger.

When the combustion chambers 5a to 5d return to less than the control pressure, the respective moving members 62a to 62d move toward their original positions, whereby the volumes of the sub chambers 61a to 61d which are communicated with the combustion chambers 5a to 5d become smaller.

In the combustion pressure control system in the present embodiment, each spring device contracts or expands when the pressures of the combustion chambers reach the control pressure. The spring device is formed so that the volumes of the sub chambers change using the pressure changes of the combustion chambers as a drive source.

The control pressure in the present invention is the pressure of the combustion chambers when the spring devices start to change. At the inside of each fluid sealing member 63, a fluid of a pressure corresponding to the control pressure is sealed. The combustion pressure control system in the present embodiment sets the control pressure so that the pressures of the combustion chambers 5 do not become pressures causing abnormal combustion or more.

The “abnormal combustion” in the present invention, for example, includes the ignition device igniting the fuel-air mixture and combustion in a state other than one of successive propagation of combustion from the point of ignition. “Abnormal combustion”, for example, includes the knocking phenomenon, the detonation phenomenon, and the pre-ignition phenomenon. The knocking phenomenon includes the spark knock phenomenon. The spark knock phenomenon is the phenomenon where the fuel-air mixture including unburned fuel at a position far from the ignition device self ignites when the ignition device ignites the fuel and a flame spreads from the ignition device at the center. The fuel-air mixture at a position far from the ignition device is compressed by the combustion gas near the ignition device and thereby becomes a high temperature and high pressure resulting in self ignition. When the fuel-air mixture self ignites, a shock wave is generated.

The detonation phenomenon is the phenomenon where the fuel-air mixture ignites due to a shock wave passing through a high temperature, high pressure fuel-air mixture. This shock wave is, for example, generated by the spark knock phenomenon.

The pre-ignition phenomenon is also referred to as the “early ignition phenomenon”. The pre-ignition phenomenon is the phenomenon where metal at the front end of the spark plug or carbon sludge which is deposited inside the combustion chamber is heated and a predetermined temperature or more is maintained whereby this part serves as the source for ignition and fuel ignites and burns before the ignition timing.

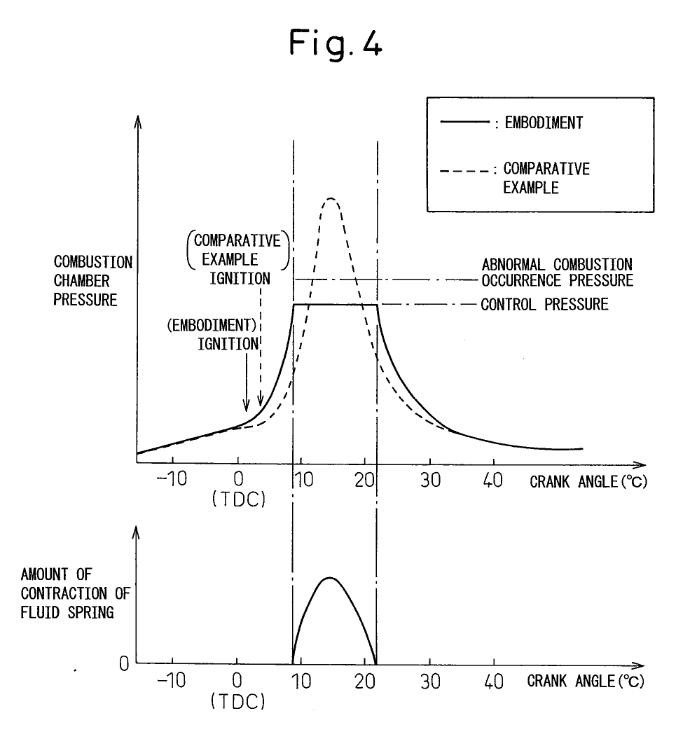

FIG. 4 is a graph of the pressure of combustion chambers in the internal combustion engine of the present embodiment. The abscissa indicates the crank angle, while the ordinate indicates the pressure of the combustion chamber and the amount of contraction of the fluid spring. FIG. 4 shows graphs of the compression stroke and expansion stroke in the combustion cycle. The amount of contraction of the fluid sealing member 63 forming the fluid spring is a value of zero when the stopping part comprised of the wall surfaces 59a, 59b and the projecting parts 60a, 60b stops the operation of extension of the fluid sealing member 63. In the combustion pressure control system in the present embodiment, if the pressure of one combustion chamber among the combustion chambers 5a to 5d reaches the control pressure, the moving members 62a to 62d which are connected to the combustion chamber move. The volume of the sub chamber which is communicated with the combustion chamber increases and the pressure rise is suppressed.

Referring to FIG. 3 and FIG. 4, in the compression stroke, the piston 3 rises and the pressure of the combustion chamber 5 rises. Here, the fluid sealing member 63 is sealed with a fluid of a pressure corresponding to the control pressure, so until the pressure of the combustion chamber 5 reaches the control pressure, the amount of contraction of the fluid sealing member 63 is zero. In the example which is shown in FIG. 4, ignition is performed slightly after a crank angle 0° (TDC). Due to ignition, the pressure of the combustion chamber 5 rapidly rises. When the pressure of the combustion chamber 5 reaches the control pressure, the fluid sealing member 63 starts to contract. The moving members start to move. When the combustion of the air-fuel mixture advances, the amount of contraction of the fluid sealing member 63 becomes larger. For this reason, the rise of the pressure of the combustion chamber 5 is suppressed. In the example which is shown in FIG. 4, the pressure of the combustion chamber 5 is held substantially constant.

In the combustion chamber, if fuel combustion further advances, the amount of contraction of the fluid sealing member 63 becomes maximum, then decreases. The pressure inside of the fluid sealing member 63 is reduced toward the original pressure. When the pressure of the combustion chamber becomes the control pressure, the amount of contraction of the fluid sealing member 63 returns to zero. When the pressure of the combustion chamber becomes less than the control pressure, the pressure of the combustion chamber 5 is reduced along with the advance of the crank angle.

In this way, the combustion pressure control system in the present embodiment suppresses the rise in the pressure of the combustion chamber when the pressure of the combustion chamber reaches the control pressure and performs control so that the pressure of the combustion chamber does not become the pressure at which abnormal combustion occurs or more.

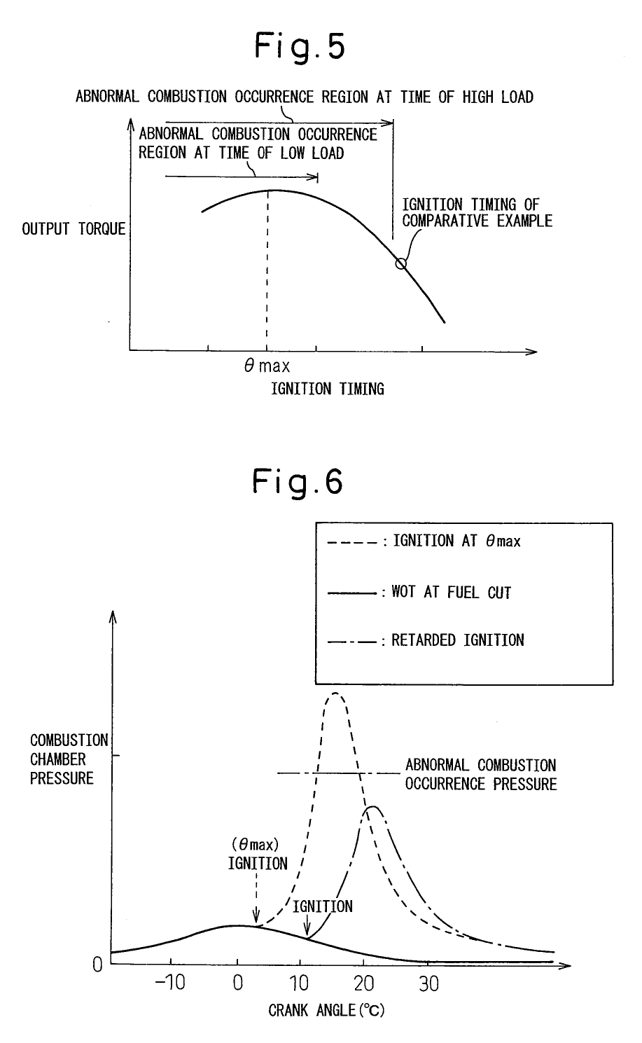

FIG. 5 shows a graph for explaining the relationship between the ignition timing and the output torque in an internal combustion engine of a comparative example. The internal combustion engine of the comparative example does not have the combustion pressure control system of the present embodiment. That is, the internal combustion engine of the comparative example does not have the spring devices. The graph of FIG. 5 is a graph of when operating the internal combustion engine of the comparative example in a predetermined state. The abscissa shows the crank angle at the time of ignition (ignition timing).

It is learned that the performance of an internal combustion engine changes depending on the timing of ignition of the fuel-air mixture. An internal combustion engine has an ignition timing (θmax) at which the output torque becomes maximum. The ignition timing at which the output torque becomes maximum changes depending on the engine speed, the throttle opening degree, the air-fuel ratio, the compression ratio, etc. By ignition at the ignition timing at which the output torque becomes maximum, the pressure of the combustion chamber becomes higher and the thermal efficiency becomes better. Further, the output torque becomes larger and the fuel consumption can be reduced. Further, the carbon dioxide which is exhausted can be reduced.

In this regard, if advancing the ignition timing, the knocking phenomenon and other abnormal combustion will occur. In particular, at a high load, the region of occurrence of abnormal combustion becomes larger. In the internal combustion engine of the comparative example, to avoid abnormal combustion, ignition is performed retarded from the ignition timing (θmax) at which the output torque becomes maximum. In this way, an ignition timing avoiding the region where abnormal combustion occurs is selected.

FIG. 6 is a graph of the pressure of combustion chambers of the internal combustion engine of the comparative example. The solid line shows the pressure of the combustion chamber when stopping the feed of fuel (fuel cut) and making the opening degree of the throttle valve wide open (WOT). The pressure of the combustion chamber at this time becomes maximum when the crank angle is 0°, that is, at compression top dead center. This pressure becomes the maximum pressure of the combustion chambers when not supplying fuel.

In an internal combustion engine, the pressure of combustion chambers fluctuates depending on the ignition timing. The graph which is shown by the broken line is a graph when igniting at the ignition timing at which the output torque becomes maximum. The broken line is a graph of the case assuming no abnormal combustion occurs. In the example which is shown in FIG. 6, ignition is performed at a timing slightly after the crank angle 0° (TDC). In the case of ignition at the ignition timing at which the output torque becomes maximum, the pressure of the combustion chamber becomes higher. However, in an actual internal combustion engine, the maximum pressure Pmax of the combustion chamber becomes larger than the pressure at which abnormal combustion occurs, so the ignition timing is retarded. The one-dot chain line is a graph when retarding the ignition timing. When retarding the ignition timing, the maximum pressure of the combustion chambers becomes smaller than when igniting at the ignition timing at which the output torque becomes maximum.

Referring to FIG. 4, the broken line is a graph of the case of ignition at the ignition timing (θmax) where the output torque becomes maximum in the internal combustion engine of the comparative example. As explained above, when igniting at this ignition timing, abnormal combustion occurs.

As opposed to this, the internal combustion engine in the present embodiment can perform combustion at a maximum pressure of the combustion chambers less than the pressure at which abnormal combustion occurs. Even if advancing the ignition timing, the occurrence of abnormal combustion can be suppressed. In particular, even in an engine with a high compression ratio, abnormal combustion can be suppressed. For this reason, compared with the internal combustion engine of the comparative example which retards the ignition timing shown in FIG. 6, the thermal efficiency can be improved and the output torque can be increased. Alternatively, the fuel consumption amount can be reduced.

Referring to FIG. 4, in the internal combustion engine of the present embodiment, ignition is performed at the ignition timing at which the thermal efficiency becomes the best. The internal combustion engine of the present embodiment can ignite the fuel at the ignition timing when the output torque of the internal combustion engine of the comparative example would become maximum. However, the internal combustion engine in the present embodiment makes the ignition timing earlier than the ignition timing at which the output torque of the internal combustion engine in the comparative example becomes maximum. Due to this configuration, the thermal efficiency can be improved more and the output torque can be increased more. In this way, the internal combustion engine in the present embodiment can ignite the fuel at the timing at which the thermal efficiency becomes the best while avoiding abnormal combustion.

It is possible to increase the control pressure over a maximum pressure of the combustion chambers in the case of stopping the supply of fuel. That is, it is possible to set it larger than a maximum pressure of the combustion chambers of the graph of the solid line which is shown in FIG. 6. Further, the control pressure can be set to less than the pressure at which abnormal combustion occurs.

In the internal combustion engine of the comparative example, the ignition timing is retarded, so the temperature of the exhaust gas becomes high. Alternatively, since the thermal efficiency is low, the temperature of the exhaust gas becomes high. In the internal combustion engine of the comparative example, to lower the temperature of the exhaust gas, sometimes the air-fuel ratio at the time of combustion is made smaller than the stoichiometric air-fuel ratio. In this regard, the three-way catalyst used in the exhaust purification system exhibits a high purification ability when the air-fuel ratio of the exhaust gas is near the stoichiometric air-fuel ratio. The three-way catalyst ends up becoming much smaller in purification performance if off from the stoichiometric air-fuel ratio. For this reason, if making the air-fuel ratio at the time of combustion smaller than the stoichiometric air-fuel ratio, the purification ability of the exhaust gas falls and the unburned fuel which is contained in the exhaust gas ends up becoming greater. Further, in the internal combustion engine of the comparative example, the temperature of the exhaust gas becomes high, so sometimes heat resistance of the exhaust purification system is demanded and high quality materials become necessary or a system for cooling the exhaust gas or a new structure for cooling the exhaust gas becomes necessary.

As opposed to this, in the internal combustion engine in the present embodiment, the thermal efficiency is high, so the temperature of the exhaust gas can be kept from becoming higher. In the internal combustion engine in the present embodiment, there is little need to reduce the air-fuel ratio at the time of combustion so as to lower the temperature of the exhaust gas. When the exhaust purification system includes a three-way catalyst, the purification performance can be maintained. Furthermore, since the temperature of the exhaust gas is kept from becoming high, the heat resistance of the members of the exhaust purification system which is demanded becomes lower. Alternatively, it is possible to form the system without newly adding a system for cooling the exhaust gas etc.

Further, referring to FIG. 4, in general, when raising the compression ratio of an internal combustion engine to raise the thermal efficiency, the maximum pressure Pmax of a combustion chamber is increased. For this reason, it is necessary to increase the strength of the members forming the internal combustion engine. However, the internal combustion engine in the present embodiment can keep the maximum pressure of the combustion chambers from becoming larger and can keep the members from becoming larger. For example, the diameter of the connecting rods can be kept from becoming larger. Further, friction between the members can be kept from becoming greater and the fuel consumption can be kept from deteriorating.

Furthermore, when the maximum pressure of the combustion chambers is high, there is the problem that enlarging the diameter of the combustion chamber is difficult. If the diameter of the combustion chamber becomes larger, a need arises to increase the strength of the support parts of the piston and other members.

However, in the present embodiment, the maximum pressure of the combustion chambers can be maintained low, so the required strength of the members can be kept low. For this reason, the diameter of the combustion chamber can be easily increased.

Next, the control pressure in the combustion pressure control system of the internal combustion engine of the present embodiment will be explained.

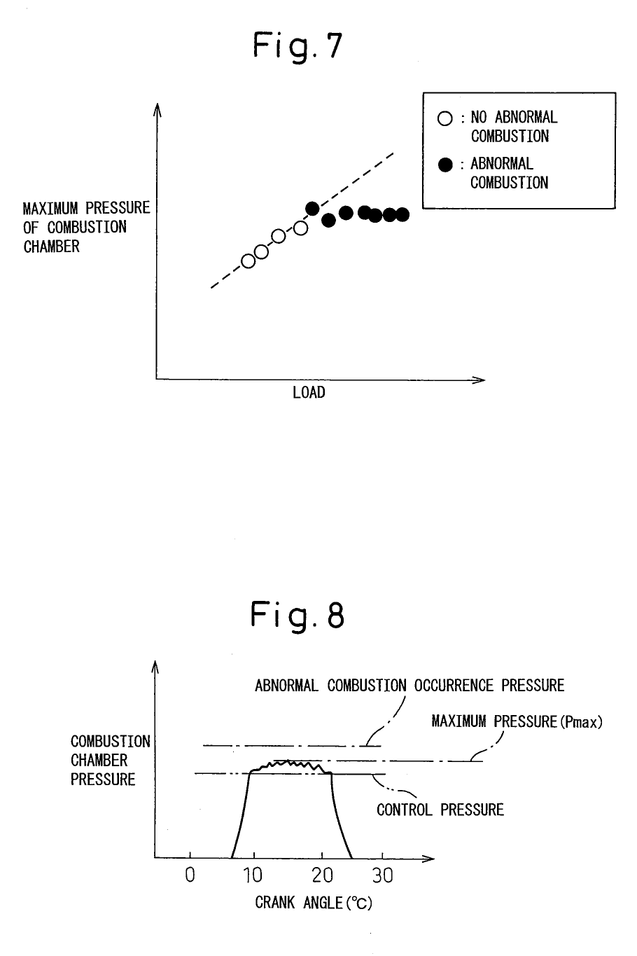

FIG. 7 is a graph which shows the relationship between the load of an internal combustion engine and the maximum pressure in a combustion chamber in the comparative example. The load of an internal combustion engine corresponds to the amount of injection of fuel in the combustion chamber. When abnormal combustion does not occur, as shown by the broken line, the maximum pressure of the combustion chambers increases along with the increase of load. If becoming greater than a predetermined load, abnormal combustion occurs. It is learned that the maximum pressure of the combustion chambers when abnormal combustion occurs is substantially constant regardless of the load.

In the internal combustion engine of the present embodiment, the control pressure is set so that the pressure of the combustion chamber does not reach the pressure where abnormal combustion occurs. As the control pressure, a large pressure in the range where the maximum pressure of the combustion chambers at the time of combustion of fuel becomes smaller than the pressure of occurrence of abnormal combustion is preferable. The control pressure is preferably raised to near the pressure at which abnormal combustion occurs. Due to this configuration, thermal efficiency can be increased while suppressing abnormal combustion.

FIG. 8 is another graph of the pressures of the combustion chambers in the internal combustion engine in the present embodiment. Referring to FIG. 2, FIG. 3, and FIG. 8, in the internal combustion engine of the present embodiment, due to the pressures of the combustion chambers 5a to 5d reaching the control pressure, the moving members 62a to 62d move and the fluid sealing members 63 contract. At this time, sometimes the pressures inside of the fluid sealing members 63 rise. For this reason, sometimes the pressures inside of the combustion chambers 5a to 5d rises along with the rise of the pressures inside of the fluid sealing members 63. The graph of the pressures of the combustion chambers 5a to 5d is an upwardly bulging shape. Therefore, when setting the control pressure, it is preferable to set it low while anticipating the amount of rise of the pressures inside of the fluid sealing members 63 so that the maximum pressure Pmax of the combustion chambers 5a to 5d does not reach the pressure of occurrence of abnormal combustion.

Next, the ignition timing of the internal combustion engine of the present embodiment will be explained.

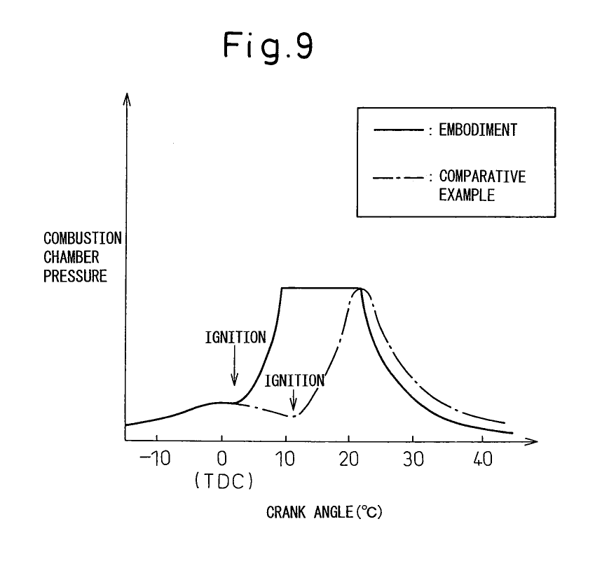

FIG. 9 is a graph of the pressures of combustion chambers in the present embodiment and the comparative example. The solid line is a graph when ignition is performed at the timing when the output torque becomes maximum in the internal combustion engine of the present embodiment. The one-dot chain line is a graph of the case of retarding the ignition timing in the internal combustion engine of the comparative example.

The internal combustion engine in the present embodiment, as explained above, preferably selects the ignition timing θmax at which the thermal efficiency of the internal combustion engine becomes maximum. However, the pressure of the combustion chamber at this ignition timing becomes high. For example, the pressure of the combustion chamber at the ignition timing of the present embodiment becomes larger than the pressure of the combustion chamber at the ignition timing of the comparative example. For this reason, depending on the internal combustion engine, sometimes sparks fail to fly and misfire ends up occurring. In particular, in the internal combustion engine of the present embodiment, ignition is performed near a crank angle 0° (TDC). With a crank angle near 0°, the pressure of the combustion chamber is high, so it is hard for sparks to fly. That is, the air density is high, so it is hard for electric discharge to occur.

Referring to FIG. 1, if the combustion chamber 5 misfires, the unburned fuel passes through the engine exhaust passage and flows into the exhaust purification system. In the present embodiment, the unburned fuel passes through the exhaust port 9 and flows into the three-way catalyst 20. In this case, sometimes the unburned fuel which flows into the three-way catalyst 20 becomes greater and the properties of the exhaust gas which is released into the atmosphere deteriorate. Alternatively, in the three-way catalyst 20, sometimes the unburned fuel burns and the three-way catalyst 20 become excessively hot.

Referring to FIG. 9, in an internal combustion engine liable to misfire in this way, the ignition timing can be made to advance. That is, the ignition timing can be made earlier. For example, the ignition timing can be made to advance more than the ignition timing at which the output torque becomes maximum. By making the ignition timing earlier, it is possible to cause ignition when the pressure of the combustion chamber is low and thereby suppress misfire.

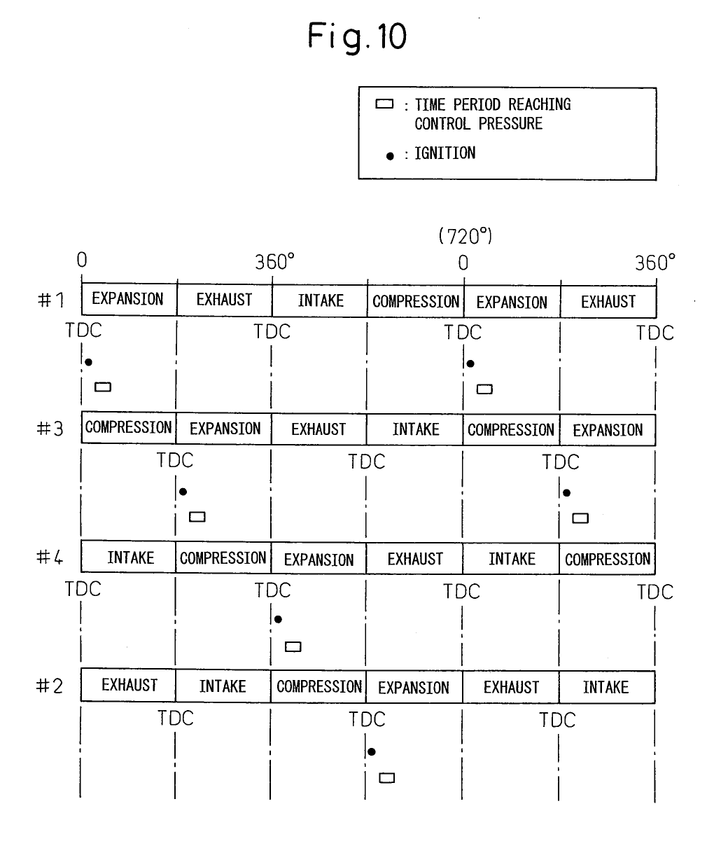

FIG. 10 shows a schematic view for explaining the strokes in the combustion cycle of an internal combustion engine in the present embodiment. The combustion cycle of each cylinder includes an intake stroke, compression stroke, expansion stroke, and exhaust stroke. In the internal combustion engine of the present embodiment, the first cylinder, third cylinder, fourth cylinder, and second cylinder are ignited in that order.

In the internal combustion engine in the present embodiment, ignition is performed at the beginning of the expansion stroke in the respective cylinders and the pressure rises. At the beginning of the expansion stroke, the pressures of the combustion chambers 5a to 5d reach the control pressure (see FIG. 4). In the present embodiment, the sub chambers of two cylinders are connected to a fluid spring. That is, one fluid spring is connected to the sub chamber 61a of the first cylinder and the sub chamber 61b of the second cylinder, while another fluid spring is connected to the sub chamber 61c of the third cylinder and the sub chamber 61d of the fourth cylinder.

In this regard, when the combustion chambers of the two cylinders which are connected to one fluid spring simultaneously reach the control pressure, the fluid sealing member 63 contracts from the ends at the both sides toward the center. The two moving members which are arranged at the two sides of the fluid sealing member 63 move together. For this reason, sometimes the pressure at the inside of the fluid sealing member 63 greatly rises and as a result the maximum pressure of the combustion chambers becomes larger. Alternatively, if, during the time period when one moving member arranged at one side of the fluid sealing member 63 is moving, the other moving member moves, the pressure inside the fluid sealing member 63 will fluctuate. For this reason, in a plurality of combustion chambers which are connected to one fluid spring, preferably, in the time period in which the pressure of one combustion chamber reaches the control pressure, the pressures of the other combustion chamber will be less than the control pressure. The internal combustion engine in the present embodiment is formed so that in the cylinders, the time periods where the pressures of the combustion chambers reach the control pressure do not overlap. For this reason, only one of the two moving members which are arranged at the two sides of a fluid sealing member moves and therefore the maximum pressure of the combustion chambers can be effectively kept from becoming higher.

Further, in the combustion chambers which are connected to one fluid spring, preferably when one combustion chamber is in an expansion stroke, the other combustion chamber is in either of an intake stroke or an exhaust stroke. More preferably, when one combustion chamber is in an expansion stroke, the other combustion chamber is in an intake stroke. Due to this configuration, it is possible to reliably avoid the pressures of the combustion chambers of the plurality of cylinders which are connected to the same fluid spring from simultaneously reaching the control pressure. When one moving member of a fluid spring is moving, it is possible to avoid the other moving member moving. For example, referring to FIG. 10, it is preferable to connect the sub chamber of the first cylinder and the sub chamber of the fourth cylinder to one fluid spring and connect the sub chamber of the second cylinder and the sub chamber of the third cylinder to the other fluid spring.

In this way, the combustion pressure control system in the present embodiment can use a single spring device to control the pressure of a plurality of combustion chambers. For this reason, the combustion pressure control system in the present embodiment can suppress the occurrence of abnormal combustion by a simple configuration. In the present embodiment, a fluid spring is connected to adjoining cylinders, but the invention is not limited to this. It is also possible to connect a fluid spring to separated cylinders. In this case, for example, it is possible to form a channel for air which extends through the inside of the cylinder head and arrange a fluid spring at the substantially intermediate position between the channel which extends from the sub chamber of one combustion chamber and the channel which extends from the sub chamber of the other combustion chamber.

Further, by connecting a single fluid spring to the sub chambers of a plurality of cylinders, it is possible to make the control pressures of the combustion chambers at the connected cylinders substantially the same. For example, it is possible to arrange one spring device for one combustion chamber. However, in this case, due to manufacturing error in the spring devices and temperature differences etc., sometimes the maximum pressures at the different combustion chambers will vary. Due to variation of the maximum pressures of the combustion chambers, the output torque will fluctuate. That is, sometimes torque fluctuation will occur. However, by connecting a single spring device to a plurality of combustion chambers, it is possible to make the control pressures of the plurality of connected combustion chambers substantially the same. As a result, it is possible to suppress torque fluctuations.

The spring device in the present embodiment includes a fluid spring which has a compressible fluid. The pressures of combustion chambers are high pressures, so it is necessary to increase the elastic force of the spring device. By employing a fluid spring as the spring device, it is possible to raise the fluid pressure which fills the inside so as to easily increase the elastic force.

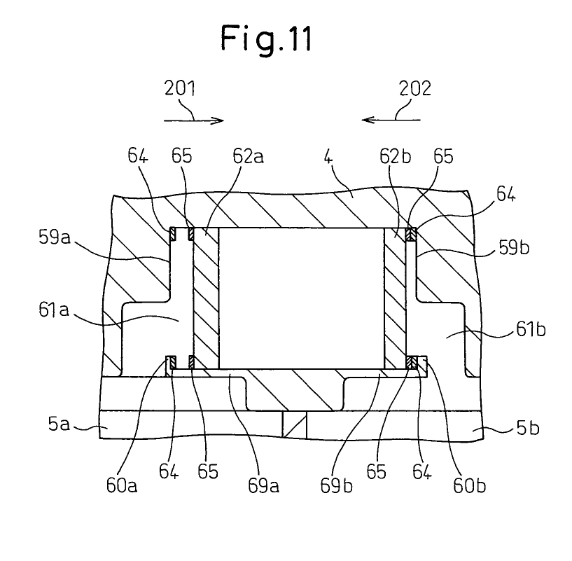

FIG. 11 show an enlarged schematic cross-sectional view of a spring device of a second combustion pressure control system in the present embodiment. The fluid spring of the second combustion pressure control system does not have a fluid sealing member. The fluid spring includes a moving member 62a and a moving member 62b. A compressible fluid is sealed between the moving member 62a and moving member 62b.

The fluid spring of the second combustion pressure control system has a sealing function which seals in air as the fluid. The sealing mechanism of the fluid includes sealing members 64, 65. The sealing members 64, 65 are arranged in the regions where the moving members 62a, 62b and the stopping parts which limit the movement of the moving members 62a, 62b face each other. The sealing members 64 in the present embodiment are arranged at the surfaces of the wall surfaces 59a, 59b of the cavities serving as the stopping parts. Further, the sealing members 64 are arranged at the surfaces of the projecting parts 60a, 60b serving as the stopping parts. Further, the sealing members 65 are arranged at the surfaces of the moving members 62a, 62b.

The sealing members 64, 65 in the present embodiment are formed ring-shaped in planar shape. The sealing members 64 and the sealing members 65 are arranged in regions which face each other. The sealing members 64, 65 are interposed between the moving members 62a, 62b and stopping parts when the moving members 62a, 62b reach the stopping parts and stop. The sealing members 64 and 65 contact each other when the pressures of the combustion chambers 5a, 5b are less than the control pressure. The sealing members 64, 65 in the present embodiment are formed by materials which suppress flow of the fluid by contacting each other. The sealing members 64, 65 in the present embodiment are formed by Fb—Mo-based sintered members. The sealing members 64, 65 are not limited to this and can be formed by any material which suppresses the flow of fluid.

When the pressures inside of the combustion chambers 5a, 5b are less than the control pressure, the moving members 62a, 62b are pushed toward the respective combustion chambers 5a, 5b. The sealing members 64 and the sealing members 65 contact each other, whereby the sealed fluid is kept from leaking to the sub chambers 61a, 61b.

When the pressures of the combustion chambers 5a, 5b become the control pressure or more, the moving members 62a, 62b move. The moving members 62a, 62b move so as to cancel out the pressure difference between the fronts and backs of the moving members 62a, 62b, so it is possible to keep the sealed fluid from leaking out to the sub chambers 61a, 61b. Further, the air of the sub chambers 61a, 61b can be kept from entering between the moving members 62a, 62b.

In this way, by arranging the sealing members 64, 65 between the moving members 62a, 62b and the stopping parts, even when there is no fluid sealing member 63, the sealed fluid can be kept from leaking to the combustion chambers. Further, the air of the combustion chambers can be kept from entering the inside of the fluid spring.

Further, the sealing members 65 in the present embodiment are arranged at the end faces of the moving members 62a, 62b. The sealing members are, for example, arranged at the outer circumferential surfaces of the moving members 62a, 62b. That is, the sealing members can be arranged between the moving members 62a, 62b and the space which is formed at the cylinder head 4. However, in this case, friction between the sealing members and the space becomes larger. By arranging the sealing members 65 at the end faces of the moving members 62a, 62b, it is possible to reduce the friction which occurs when the moving members 62a, 62b move. The moving members 62a, 62b can be made to smoothly move and a spring device superior in response can be formed.

The spring device in the present embodiment has sealing members arranged at both the surfaces of the moving members and the surfaces of the stopping parts which limit movement of the moving members, but the invention is not limited to this. The sealing members may also be arranged at just one of the moving members and stopping parts.

The sealing mechanism which is formed by the moving members and stopping parts is not limited to the above. Any sealing mechanism can be employed. For example, by reducing the surface roughness of the moving members and the surface roughness of the stopping parts which contact the moving members, it is also possible for the mechanism to be formed to suppress the flow of the fluid.

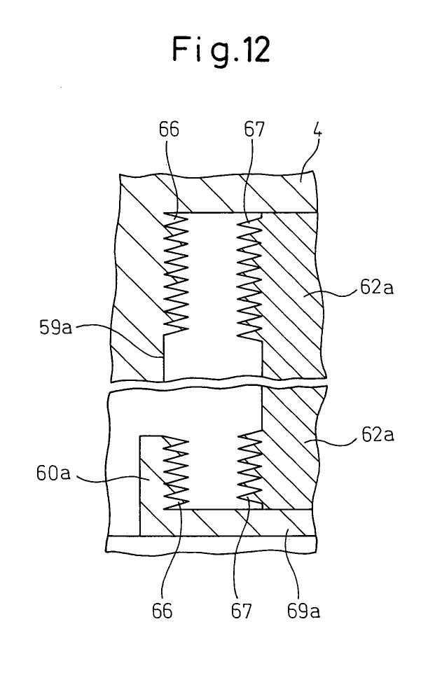

FIG. 12 shows an enlarged schematic cross-sectional view of a spring device of a third combustion pressure control system in the present embodiment. FIG. 12 is an enlarged schematic cross-sectional view of the outer circumference part of a moving member and stopping part. The spring device of the third combustion pressure control system has a heat transfer mechanism which promotes heat transfer between the cylinder head and the moving members. The heat transfer mechanism has a concave-convex portion 67 which is arranged at the end faces of the moving members 62a. Further, the heat transfer mechanism has a concave-convex portion 66 which is formed at the wall surface 59a of the cylinder head and the surface of the projecting part 60a of the seat part 69a. The concave-convex portion 66 and the concave-convex portion 67 are arranged so as to face each other. The concave-convex portion 66 is formed so as to fit with and closely contact the concave-convex portion 67. That is, the valley parts of the concave-convex portion 66 are formed so as to contact the peak parts of the concave-convex portion 67.

By the concave-convex portion 66 and the concave-convex portion 67 contacting, the heat transfer area can be made larger. For this reason, even when the temperature of the fluid which is sealed at the inside of the moving members changes, it is possible to release the heat to the cylinder head 4 through the moving members 62a, 62b. For this reason, it is possible to suppress change of the temperature of the fluid which is sealed between the moving members 62a, 62b. It is possible to suppress a change in the temperature of the compressible fluid at the inside of the fluid spring. As a result, it is possible to suppress change in the maximum pressure of the combustion chambers due to temperature changes.

Further, the concave-convex portions 66, 67 also function as a sealing mechanism for suppressing leakage of fluid which is sealed between the moving members 62a, 62b. Due to the engagement of the concave-convex portion 66 and the concave-convex portion 67, the moving members and the stopping parts contact by a large contact area and suppress flow of the fluid. Further, even when a clearance is partially formed between the concave-convex portion 66 and the concave-convex portion 67, it is possible to form a labyrinth seal and suppress flow of the fluid. For this reason, it is possible to suppress leakage of the fluid which is sealed between the moving member 62a and the moving member 62b toward the combustion chambers or entry of air of the combustion chambers into the space sandwiched between the moving member 62a and moving member 62b.

In the present embodiment, the concave-convex portion 66, 67 are formed in concentric circular shapes. Due to this configuration, even if the moving members 62a, 62b rotate at the inside of the space of the cylinder head 4, it is possible to reliably fit together the concave-convex portion 66 and the concave-convex portion 67.

In the present embodiment, as the fluid which is sealed in a fluid spring, a gas was taken as an example for the explanation, but the invention is not limited to this. The fluid which is sealed at the inside of a fluid spring may also include a liquid. For example, the fluid which is sealed at the inside of the fluid spring may also be a mixture of a liquid and a gas. The inside of the fluid spring need only contain a compressible fluid.

The fluid spring in the present embodiment includes moving members, but the invention is not limited to this. The fluid spring may also be formed to include a compressible fluid and be able to expand and contract by a desired pressure.

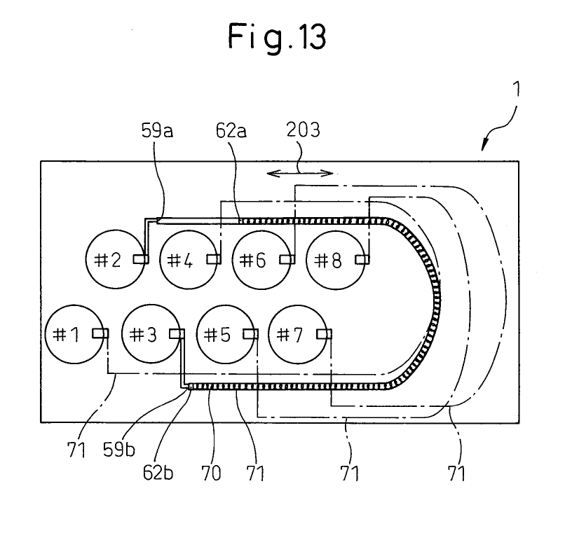

FIG. 13 shows a schematic view of an internal combustion engine which provided with a fourth combustion pressure control system in the present embodiment. FIG. 13 is a schematic view when viewing the engine body by a plane view. The internal combustion engine provided with the fourth combustion pressure control system of the present embodiment is an 8-cylinder engine. The fourth combustion pressure control system is provided with a spring device which is connected to the sub chambers of a plurality of cylinders separated from each other.

The spring device of the fourth combustion pressure control system has a passage 71 which connects the sub chamber of the second cylinder and the sub chamber of the third cylinder. The passage 71 in the present embodiment is formed inside of the cylinder head. The passage 71 is formed so as to surround the region in which the plurality of cylinders are arranged.

The spring device of the fourth combustion pressure control system includes a mechanical spring which is arranged inside of the passage 71. In the example which is shown in FIG. 13, a coil spring 70 is arranged. The spring device includes moving members 62a, 62b which are arranged at the two sides of the coil spring 70. The spring device has wall surfaces 59a, 59b where the passage 71 becomes smaller in diameter serving as stopping parts. The coil spring 70, as shown by the arrow 203, contracts by at least one of the moving member 62a and moving member 62b being pressed. The coil spring 70 expands and contracts along the passage 71. The moving members 62a, 62b stop by contacting the wall surfaces 59a, 59b. That is, the wall surfaces 59a, 59b function as stopping parts which limit movement of the moving members.

In the example which is shown in FIG. 13, a passage 71 which connects the sub chamber of the fourth cylinder and the sub chamber of the first cylinder, a passage 71 which connects the sub chamber of the sixth cylinder and the sub chamber of the seventh cylinder, and a passage 71 which connects the sub chamber of the eighth cylinder and the sub chamber of the fifth cylinder are formed. These passages are formed so as to surround the plurality of cylinders. At the insides of the passages 71, coil springs and moving members are arranged.

Combustion chambers are high pressure, so the pressures of the combustion chambers when the moving members start to move, that is, the control pressure, also become high pressure. The spring device has to push the moving members by a large pushing force. The spring device may include a coil spring 70. In this regard, to generate a large pushing force, an extremely long coil spring 70 sometimes becomes necessary. In the fourth combustion pressure control system of the present invention, it is possible to lengthen the passage in which the coil spring 70 is arranged and possible to employ a mechanical spring as the elastic member of the spring device.

The combustion pressure control system in the present embodiment has one spring device connected to the sub chambers of two cylinders, but the invention is not limited to this. One spring device may also be connected to the sub chambers of three or more cylinders. Further, in the present embodiment, the explanation was given with reference to the example of a 4-cylinder internal combustion engine or an 8-cylinder internal combustion engine, but the invention is not limited to this. The present invention may be applied to any internal combustion engine which is provided with a plurality of cylinders.

The combustion pressure control system in the present embodiment is formed to change the volume of one of the sub chambers among the plurality of sub chambers which are connected to the spring device, but the invention is not limited to this. The system may also be formed so as to simultaneously change the volumes of two or more sub chambers. That is, the present invention can be applied even to an internal combustion engine wherein the two or more combustion chambers which are connected to one spring device simultaneously reach the control pressure.

### Embodiment 2

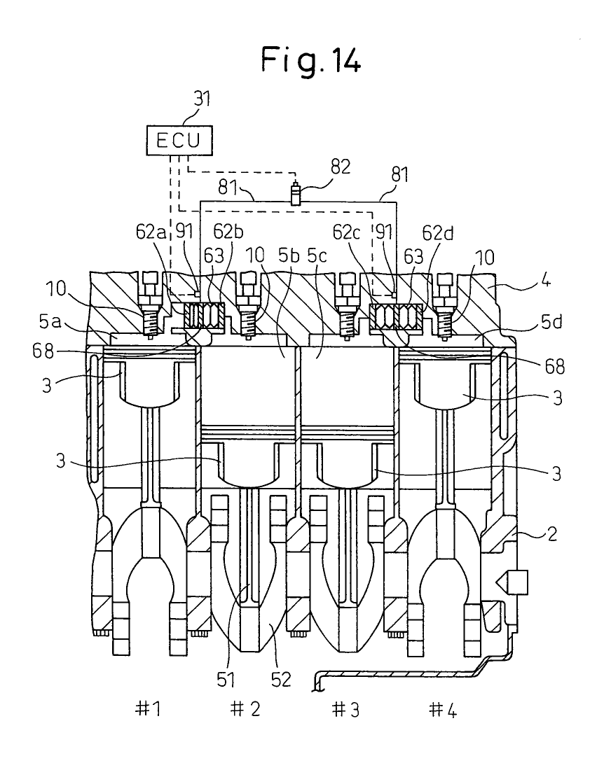

Referring to FIG. 14 to FIG. 20, a combustion pressure control system in an Embodiment 2 will be explained. In the present embodiment, the explanation will be given with reference to the example of a 4-cylinder internal combustion engine. The combustion pressure control system in the present embodiment is provided with a connecting device which connects the spaces inside the plurality of fluid springs.

FIG. 14 is a schematic cross-sectional view of an internal combustion engine which is provided with the first combustion pressure control system in the present embodiment. A spring device is arranged between the combustion chamber 5a of the first cylinder and the combustion chamber 5b of the second cylinder. Further, a spring device is arranged between the combustion chamber 5c of the third cylinder and the combustion chamber 5d of the fourth cylinder. Each spring device in the present embodiment includes a fluid spring.

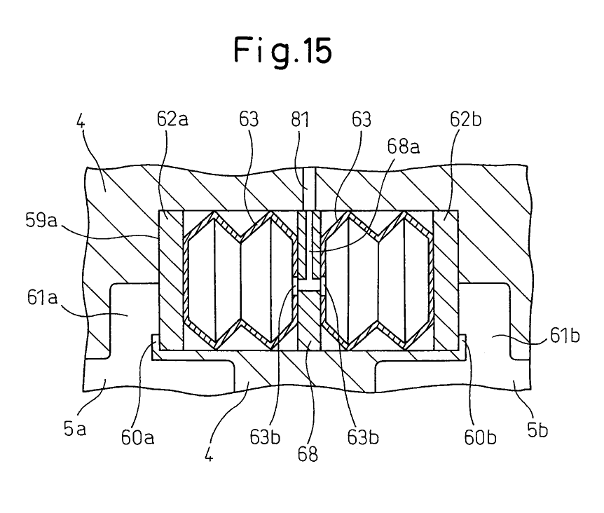

FIG. 15 shows an enlarged schematic cross-sectional view of a part of a spring device in the first combustion pressure control system of the present embodiment. Referring to FIG. 14 and FIG. 15, each fluid spring in the present embodiment includes an intermediate member 68. The intermediate member 68 in the present embodiment is fixed to the cylinder head 4. The intermediate member 68 is formed so as not to move even if the fluid sealing member 63 extends or contracts. The intermediate member 68 is, for example, arranged at the substantial center of the sub chambers 61a, 61b. The fluid springs in the present embodiment include the moving members 62a to 62d.

A fluid sealing member 63 is arranged between the moving member 62a and the intermediate member 68 arranged at the sub chamber 61a side of the first cylinder. Further, similarly, fluid sealing members 63 are arranged between the moving members 62b to 62d and intermediate members 68. These fluid sealing members 63 are formed with openings 63b at the surfaces contacting the intermediate members 68.

Inside of each intermediate member 68, a channel 68a is formed. The channel 68a is formed so as to communicate with the insides of the fluid sealing members 63. The channel 68a communicates with the openings 63b of the fluid sealing members 63. In this way, it is formed so that air flows between the channel 68a and the inside of the fluid sealing members 63. The cylinder head 4 is formed with channels 81. The channels 81 communicate with the channels 68a of the intermediate members 68.

Referring to FIG. 14, the channel 81 which is connected to the fluid spring which is arranged between the first cylinder and the second cylinder and the channel 81 which is connected to the fluid spring which is arranged between the third cylinder and the fourth cylinder are connected with each other through an on-off valve 82. The on-off valve 82 is connected to the electronic control unit 31. The on-off valve 82 is controlled by the electronic control unit 31. By opening the on-off valve 82, the spaces at the insides of the fluid springs can be connected. By connecting the spaces at the insides of the plurality of fluid springs, it is possible to enlarge the space in which the fluid is sealed.

Referring to FIG. 10, the time period in which the pressures of the combustion chambers reach the control pressure is equal to the time period in which the moving members which correspond to the cylinders move. In the internal combustion engine of the present embodiment, when a moving member corresponding to any of the cylinders moves, the moving members which correspond to the other cylinders stop. For this reason, by opening the on-off valve 82, the not expanding or contracting fluid springs are connected to the expanding or contracting fluid spring. This state is equivalent to a device which connects a fluid storage part to an expanding or contracting fluid spring.

As shown in FIG. 8, the maximum pressure which the combustion chambers reach depends on the volume of the space in which the fluid is sealed. By the volume of the space of the fluid spring in which the fluid is sealed becoming smaller, the rise in the pressure at the inside of the fluid spring when the fluid spring contracts becomes larger. That is, the maximum pressure of the combustion chambers becomes larger. By the volume of the space in which the fluid is sealed becoming larger, the rise of the pressure at the inside of the fluid spring when the fluid spring contracts can be reduced. Further, it is possible to reduce the maximum pressure which the combustion chambers reach.

The control device of an internal combustion engine in the present embodiment can perform control to increase the volume of the space in which the fluid is sealed when the maximum pressure of the combustion chambers demanded is low. Further, when the maximum pressure of the combustion chambers demanded is high, it can perform control so as to reduce the volume of the space in which the fluid is sealed.

Referring to FIG. 14, when the maximum pressure of the combustion chambers demanded is low, it is possible to perform control to open the on-off valve 82. When the maximum pressure of the combustion chambers demanded is low, it is possible to connect a plurality of fluid springs. For example, if ignition is performed at the combustion chamber 5a of the first cylinder, the moving member 62a moves and the fluid sealing member 63 contracts. At this time, the moving members 62b, 62c, and 62d are in a stopped state. By setting the on-off valve 82 in the open state during the time period in which the moving member 62a is moving, it is possible to enlarge the space in which the fluid is sealed. It is possible to suppress a pressure rise at the inside of the fluid spring. For this reason, it is possible to suppress the pressure rise in the combustion chambers and reduce the maximum pressure of the combustion chambers.

In this regard, the combustion pressure control system in the present embodiment is provided with an operating state detecting device which detects an operating state of the internal combustion engine. The combustion pressure control system in the present embodiment selects the maximum pressure which the combustion chambers reach based on the operating state of the internal combustion engine which is detected. It changes the volume of the space in which the fluid is sealed based on the operating state at any point of time.

Here, the operating state of the internal combustion engine for changing the maximum pressure of the combustion chambers will be explained with reference to the example of the engine speed. Referring to FIG. 1, the operating state detecting device includes a crank angle sensor 42 for detecting the engine speed.

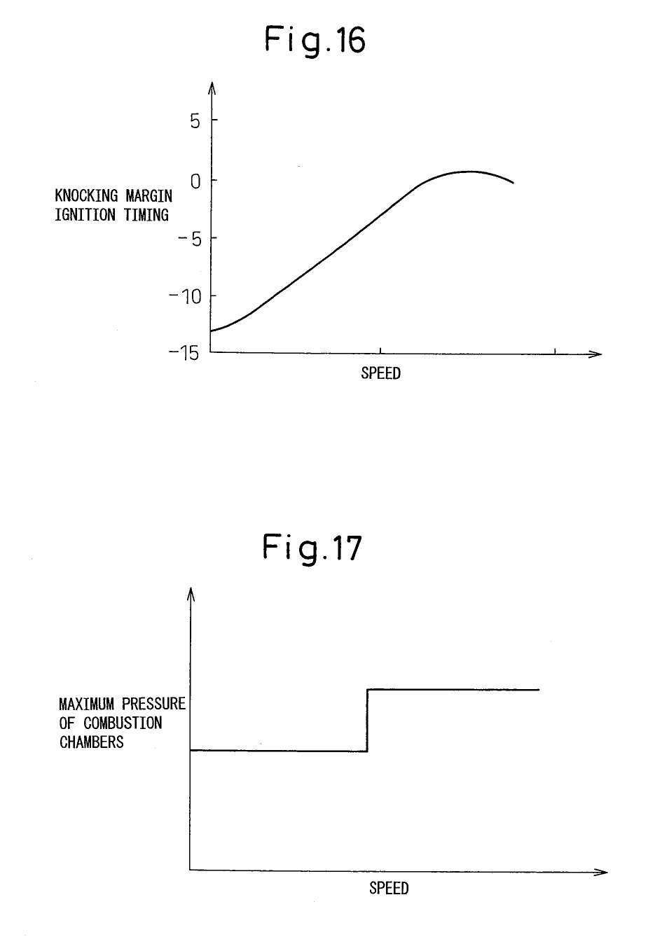

FIG. 16 is a graph which explains the relationship between the speed of an internal combustion engine of a comparative example and a knock margin ignition timing. The internal combustion engine of the comparative example is an internal combustion engine which does not have a fluid spring of the present embodiment. The knock margin ignition timing can be expressed by the following formula:

(Knock margin ignition timing)−(ignition timing at which knocking occurs)−(ignition timing at which output torque becomes maximum)

The smaller the knock margin ignition timing in value, the easier it is for abnormal combustion to occur. The ease of occurrence of knocking differs depending on the speed of the internal combustion engine. For this reason, in the combustion pressure control system of the present embodiment, the speed of the internal combustion engine is used as the basis to change the maximum pressure of the combustion chambers. The internal combustion engine generally becomes resistant to abnormal combustion when the speed of the internal combustion engine rises since the combustion period becomes shorter.

FIG. 17 is a graph of the maximum pressure of the combustion chambers against the speed of the internal combustion engine in the combustion pressure control system in the present embodiment. The higher the speed of the internal combustion engine, the higher the maximum pressure of the combustion chambers. Referring to FIG. 1, in the present embodiment, the maximum pressure of the combustion chambers is stored as a function of the speed of the internal combustion engine in advance in the ROM 34 of the electronic control unit 31. The electronic control unit 31 uses the crank angle sensor 42 to detect the speed of the internal combustion engine and selects the maximum pressure of the combustion chambers in accordance with the speed. The electronic control unit 31 controls the on-off valve 82 so that the volume in which the fluid is sealed corresponds to the maximum pressure of the combustion chambers selected. In the example which is shown in FIG. 17, control may be performed to close the on-off valve 82 when the speed of the internal combustion engine becomes larger than a predetermined value.

Further, the operating state detecting device of the combustion pressure control system in the present embodiment includes a fuel property detecting device which detects a property of the fuel which is supplied to the combustion chambers. The detected property of the fuel is used as the basis to change the maximum pressure of the combustion chambers demanded. The fuel of an internal combustion engine sometimes contains alcohol. In the present embodiment, an internal combustion engine which detects the alcohol concentration as the property of the fuel is explained as an example. The characteristics of the internal combustion engine at the time of operation depend on the alcohol concentration.

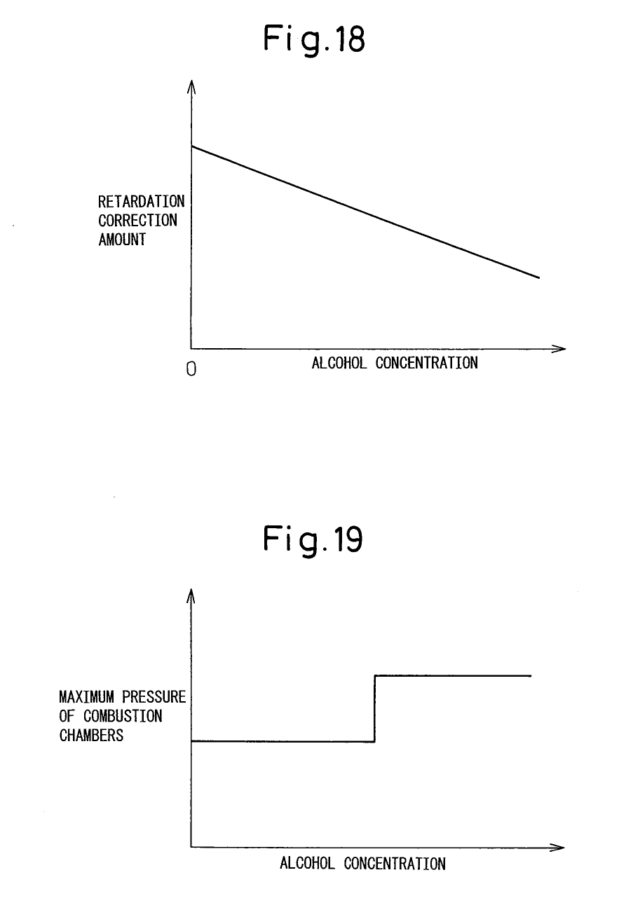

FIG. 18 shows a graph which explains the relationship between the alcohol concentration which is contained in the fuel and a retardation correction amount in an internal combustion engine of a comparative example. The internal combustion engine of the comparative example retards the ignition timing when abnormal combustion occurs. The abscissa in FIG. 18 indicates the alcohol concentration which is contained in the fuel, while the ordinate indicates the retardation correction amount when retarding the ignition timing so that abnormal combustion does not occur. The higher the alcohol concentration which is contained in the fuel, the smaller the retardation correction amount becomes. In this way, an internal combustion engine becomes more resistant to abnormal combustion the higher the alcohol concentration. For this reason, in the combustion pressure control system in the present embodiment, the alcohol concentration which is contained in the fuel is used as the basis to change the maximum pressure of the combustion chambers.

FIG. 19 is a graph of the maximum pressure of the combustion chambers with respect to the alcohol concentration in the combustion pressure control system in the present embodiment. The higher the alcohol concentration, the higher the maximum pressure of the combustion chambers is set. The fuel property detecting device in the present embodiment includes an alcohol concentration sensor which detects the alcohol concentration which is contained in the fuel. Referring to FIG. 1, the internal combustion engine in the present embodiment has an alcohol concentration sensor arranged in the fuel feed channel as the fuel property sensor 77. The maximum pressure of the combustion chambers which is demanded is stored as a function of the alcohol concentration in advance in the ROM 34 of the electronic control unit 31. The electronic control unit 31 detects the alcohol concentration which is contained in the fuel and selects the maximum pressure of the combustion chambers in accordance with the alcohol concentration. The electronic control unit 31 controls the on-off valve 82 so that the volume at the inside of the fluid sealing member 63 corresponds to the selected control pressure. In the example which is shown in FIG. 19, control is possible to close the on-off valve 82 when the alcohol concentration which is contained in the field becomes larger than a predetermined value.

In the combustion pressure control system of the present embodiment, two fluid springs are connected through a channel 81 so as to select two stages of the maximum pressure of the combustion chambers. The operation of one on-off valve 82 is controlled for two-stage control. The combustion pressure control system in the present embodiment can be applied to an internal combustion engine which is provided with a greater number of cylinders. For example, in an internal combustion engine which is provided with three or more fluid springs, a connecting passage which connects the internal spaces of a plurality of fluid springs is formed. On-off valves are arranged in the connecting passage which is connected to the fluid springs. By changing the number of other fluid springs which are connected to an expanding or contracting fluid spring, it is possible to change the maximum pressure of the combustion chambers in multiple stages.

As the operating state of the internal combustion engine, in addition to the speed of the internal combustion engine and the property of the fuel which is supplied to the combustion chambers, the intake temperature, the cooling water temperature of the internal combustion engine, the temperature of the combustion chamber immediately before ignition, etc. may be illustrated. The lower these temperatures, the higher the maximum pressure of the combustion chambers can be set. For example, an internal combustion engine becomes more resistant to abnormal combustion the lower the temperature of the air-fuel mixture at the time of ignition. Furthermore, when the compression ratio of an internal combustion engine is variable, the lower the compression ratio, the lower the temperature at the time of ignition. For this reason, the lower the compression ratio, the higher the maximum pressure of the combustion chambers can be set.

As the property of the fuel, in addition to the alcohol concentration, the octane value of gasoline or other indicators which show the knocking resistance can be illustrated. For example, it is possible to detect the supply of fuel with a high octane value or other fuel resistant to abnormal combustion to a combustion chamber and raise the maximum pressure of the combustion chambers.

By changing the maximum pressure of the combustion chambers in accordance with the operating state of the internal combustion engine in this way, abnormal combustion can be kept from occurring while increasing the maximum pressure of the combustion chambers. Abnormal combustion can be kept from occurring while increasing the output torque or suppressing fuel consumption in accordance with the operating state.

In the internal combustion engine of the present embodiment, for example, when the moving member 62a of the first cylinder is moving and the fluid sealing member 63 is contracted, the moving members 62b, 62c, 62d of the other fluid springs are held in the stopped state. If the moving members of other fluid springs move during the time period where the moving member of one fluid spring moves, sometimes pressure fluctuation of the fluid which is sealed inside occurs. Further, if the pressure of the fluid which is sealed inside becomes larger, sometimes the maximum pressure of the combustion chambers becomes larger. For this reason, when connecting a plurality of fluid springs together, it is preferable that the moving members of all of the other fluid springs stop during the time period when the moving member of one fluid spring is moving.

Further, the combustion pressure control system of the present embodiment can correct pressure fluctuations due to temperature changes of the fluid at the inside of a fluid spring etc. Referring to FIG. 14, the combustion pressure control system in the present embodiment is provided with pressure sensors 91 which detect the pressures at the insides of the fluid springs. Each pressure sensor 91 in the present embodiment is arranged in the channel 81 between an intermediate member 68 and the on-off valve 82. The pressure sensor 91 is connected to the electronic control unit 31. The output of the pressure sensor 91 can be used to detect the pressure at the inside of a fluid spring.

For example, when the temperature around a fluid spring rises and the temperature of the fluid inside of the fluid spring becomes higher, the pressure of the fluid rises. As a result, the pressures of the combustion chambers at which the moving members 62a to 62d start to move becomes higher. That is, the control pressure becomes higher. In such a case, it is possible to increase the number of other fluid springs which are connected to an expanding or contracting single fluid spring so as to keep down the maximum pressure which is reached at the combustion chambers. Further, control is possible to reduce the number of other fluid springs which are connected to the single fluid spring the lower the pressure at the inside of the fluid spring. In this way, it is possible to keep temperature changes etc. from causing the pressure at the inside of the fluid spring to change and the maximum pressure which the combustion chambers reach from changing. It is possible to reduce the deviation from the targeted maximum pressure of the combustion chambers.

The combustion pressure control system of the present embodiment detects the pressure at the inside of a fluid sealing member, but the invention is not limited to this. It is also possible to estimate the pressure at the inside of the fluid sealing member. For example, it is also possible to arrange a temperature sensor instead of a pressure sensor and detect the temperature so as to estimate the pressure at the inside of the fluid spring. The higher the temperature at the inside of the fluid spring, the more the pressure of the fluid which is sealed at the inside of the fluid spring rises. For this reason, control is possible to increase the number of other fluid springs which are connected to an expanding or contracting fluid spring the higher the temperature which is detected from the temperature sensor.

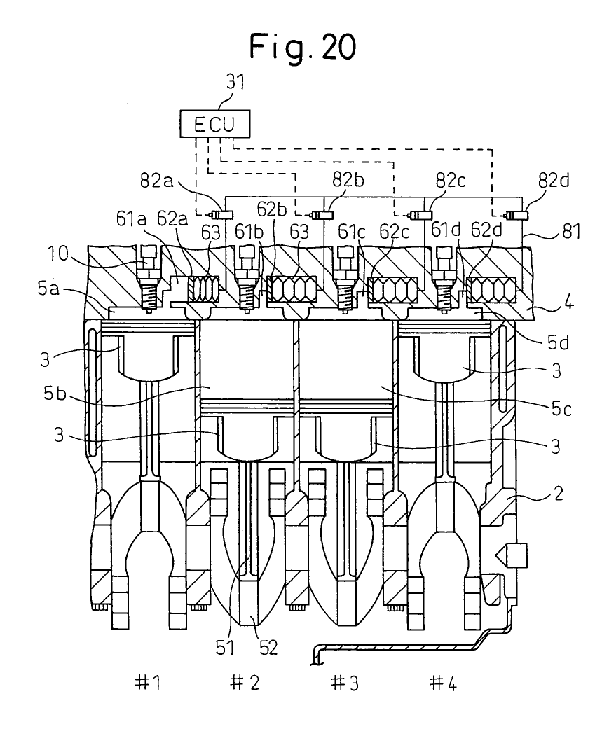

FIG. 20 shows a schematic cross-sectional view of an internal combustion engine provided with a second combustion pressure control system in the present embodiment. In the second combustion pressure control system of the present embodiment, spring devices are arranged for the respective cylinders. The spring devices include fluid springs. The fluid springs are connected to the sub chambers 61a to 61d which are communicated with the combustion chambers 5a to 5d. The fluid springs have fluid sealing members 63.

The fluid sealing members 63 are connected to the channels 81. In the channels 81 of the cylinders, on-off valves 82a to 82d are arranged. The channels 81 are connected to each other through the on-off valves 82a to 82d. The on-off valves 82a to 82d are connected to the electronic control unit 31. The on-off valves 82a to 82d are controlled by the electronic control unit 31.

The second combustion pressure control system of the present embodiment is provided with a plurality of fluid springs which can be connected to one fluid spring. The second combustion pressure control system of the present embodiment, like the first combustion pressure control system in the present embodiment, is provided with an operating state detecting device which detects the operating state of the internal combustion engine and has the maximum pressure of the combustion chambers selected in accordance with the detected operating state. The number of the other fluid springs which are connected to the fluid spring which expands or contracts is changed in accordance with the selected maximum pressure of the combustion chambers. It is possible to perform control to reduce the number of fluid springs which are connected to one fluid spring the higher the selected maximum pressure of the combustion chambers. Due to this configuration, it is possible to change the volume of the space in which the fluid is filled in accordance with the selected maximum pressure of the combustion chambers. It is possible to adjust the maximum pressure which the combustion chambers reach.

For example, when the selected maximum pressure of the combustion chambers is low, by making all of the on-off valves 82a to 82d the open state during the time period in which the moving member 62a which is arranged at the first cylinder is moving, the fluid sealing member 63 of the second cylinder, the fluid sealing member 63 of the third cylinder, and the fluid sealing member 63 of the fourth cylinder are connected to the fluid sealing member 63 which is connected to the sub chamber 61a of the first cylinder. It is possible to enlarge the space in which the fluid is sealed and possible to lower the maximum pressure which the combustion chamber 5a of the first cylinder reaches.

Further, in the same way as the first combustion pressure control system in the present embodiment, pressure sensors etc. are arranged for detecting the pressures at the insides of the fluid springs. It is possible to change the number of other fluid springs which are connected to the expanding or contracting fluid springs in accordance with the pressure at the inside of the fluid springs which changes according to the temperature etc. It is possible to keep the pressure at the insides of the fluid springs from changing depending on the temperature, etc., and keep the maximum pressure which the combustion chambers reach from changing.

The rest of the configuration, action, and effects are similar to those of the Embodiment 1, so their explanations will not be repeated here.

### Embodiment 3

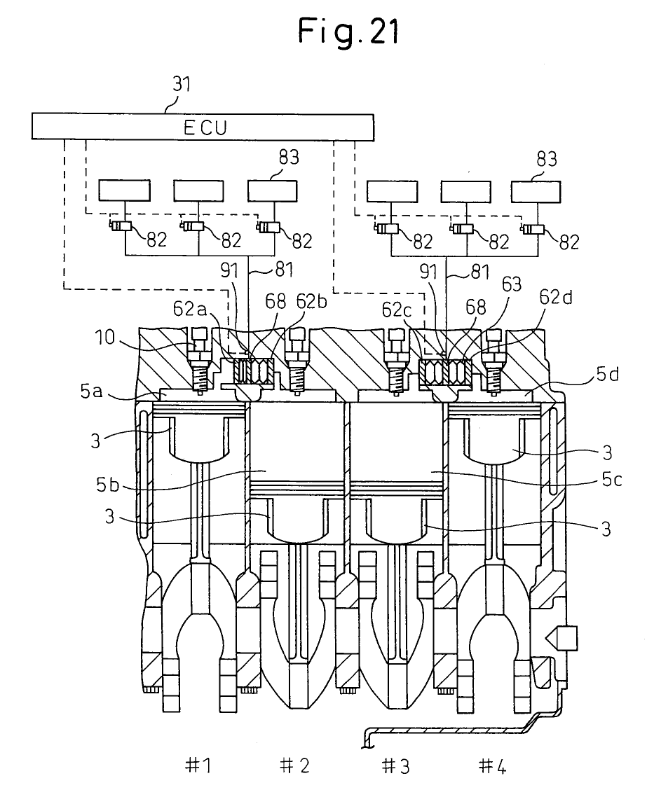

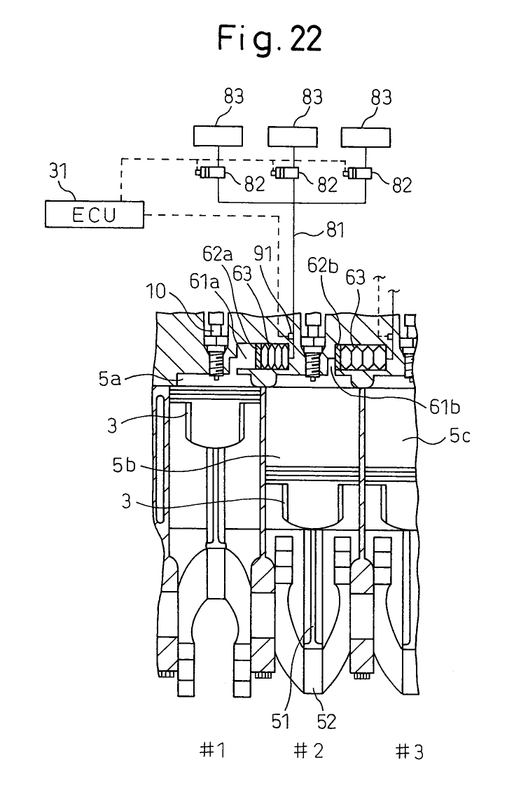

Referring to FIG. 21 and FIG. 22, a combustion pressure control system in Embodiment 3 will be explained. The combustion pressure control system in the present embodiment is provided with a fluid storage part which is connected to the fluid springs and which stores fluid and a volume adjusting device which changes the volume of the fluid storage part.

FIG. 21 is a schematic cross-sectional view of an internal combustion engine which is provided with the first combustion pressure control system in the present embodiment. In the present embodiment, a 4-cylinder internal combustion engine will be taken as an example for the explanation. A spring device is arranged between the first cylinder and the second cylinder. Further, a spring device is arranged between the third cylinder and the fourth cylinder.

Each spring device in the present embodiment includes a fluid spring. The fluid spring has an intermediate member 68. The intermediate member 68 has a channel 68a inside of it (see FIG. 15). Between the moving members 62a to 62d and the intermediate members 68, fluid sealing members 63 are arranged. At the insides of the fluid sealing members 63, air flows through channels 68a which are formed in the intermediate members 68.

The combustion pressure control system of the present embodiment includes channels 81 which are connected to the intermediate members 68. The channels 81 have fluid tanks 83 connected to them forming the fluid storage part. In the present embodiment, a plurality of fluid tanks 83 are connected to a single fluid spring. In the middle of the channels 81 which communicates with the fluid tanks 83, on-off valves 82 which open and close the channels 81 are arranged. The respective on-off valves 82 are connected to the electronic control unit 31. The on-off valves 82 are controlled independently by the electronic control unit 31.

The combustion pressure control system in the present embodiment can change the number of the fluid tanks 83 which are connected to an expanding or contracting fluid spring by controlling the on-off states of the on-off valves 82. It is possible to change the number of fluid tanks which are connected so as to change a volume of the fluid storage part. That is, it is possible to change the volume of the space in which the fluid is sealed.

The combustion pressure control system in the present embodiment is provided with an operating state detecting device which detects the operating state of the internal combustion engine. The maximum pressure of the combustion chambers is selected in accordance with the operating state. It is possible to change the volume of the space in which the fluid is filled in accordance with the selected maximum pressure of the combustion chambers. It is possible to perform control to increase the number of the fluid tanks 83 which are connected to an expanding or contracting fluid spring the lower the selected maximum pressure of the combustion chambers.

The combustion pressure control system in the present embodiment has pressure sensors 91 arranged at the channels 81 which are communicated with the intermediate members 68. The outputs of the pressure sensors 91 can be used to detect the pressures at the inside of the fluid springs. The combustion pressure control system in the present embodiment can detect the pressures of the fluid inside of the fluid springs and use the pressures of the fluid as the basis to change the number of fluid tanks 83 which are connected. For example, by the temperature of the fluid which is sealed in a fluid sealing member 63 rising, the pressure when the moving members 62a to 62d start to move rises. As a result, the maximum pressure which the combustion chambers reach rises. In such a case, it is possible to increase the number of fluid tanks 83 which are connected to the fluid springs so as to keep the maximum pressure which the combustion chambers 5 reach from becoming larger. By performing such control, it is possible to keep the pressures at the inside of the fluid springs from changing depending on the temperatures, etc., and keep the maximum pressure which the combustion chambers reach from changing. It is possible to reduce the deviation from the targeted maximum pressure of the combustion chambers.

Further, by connecting a plurality of fluid tanks to the fluid springs, it is possible to change the number of fluid tanks which are connected to an expanding or contracting fluid spring in multiple stages. It is possible to change the volume of the space in which the fluid is sealed in multiple stages. As a result, it is possible to perform control more finely. For example, it is possible to control the maximum pressure which the combustion chambers reach in multiple stages in accordance with the operating state of the internal combustion engine. Further, it is possible to perform adjustment in multiple stages when reducing the deviation from the targeted maximum pressure of the combustion chambers as well.

FIG. 22 shows a schematic cross-sectional view of an internal combustion engine provided with a second combustion pressure control system in the present embodiment. The second combustion pressure control system has a spring device connected for every of the individual combustion chambers 5a, 5b. The spring devices include fluid springs. The fluid springs are connected through channels 81 to a plurality of fluid tanks 83. The channels 81 which are communicated with the fluid tanks 83 have on-off valves 82 arranged in them for opening and closing the channels 81. These on-off valves 82 are independently controlled by the electronic control unit 31.

In the second combustion pressure control system of the present embodiment as well, it is possible to change the number of fluid tanks connected to the fluid springs in accordance with the maximum pressure of the combustion chambers which is selected in accordance with the operating state of the internal combustion engine. For example, it is possible to increase the number of fluid tanks which are connected to the fluid springs when the maximum pressure of the combustion chambers which is selected becomes low in accordance with the operating state of the internal combustion engine.

Further, it is possible to detect the pressures of the fluid inside of the fluid springs and use the detected pressures of the fluid as the basis to change the number of the connected fluid tanks 83. It is possible to change the number of connected fluid tanks when the pressure at the inside of the fluid springs changes. For example, it is possible to increase the number of the connected fluid tanks 83 when the pressures at the inside of the fluid springs rise due to a temperature rise. By performing such control, it is possible to reduce the deviation from the target maximum pressure of the combustion chambers.

The rest of the configuration, action, and effects are similar to those of the Embodiment 1 or 2, so their explanations will not be repeated here.

The above embodiments may be suitably combined. In the above figures, the same or corresponding parts are assigned the same reference numerals. Note that the above embodiments are illustrations and do not limit the invention. Further, the embodiments include changes covered by the claims.

### REFERENCE SIGNS LIST

1 engine body
3 piston
4 cylinder head
5, 5a to 5d combustion chamber
31 electronic control unit
59a, 59b wall surface
60a, 60b projecting part
61a to 61d sub chambers
62a to 62d moving member
63 fluid sealing member
64, 65 sealing member
66, 67 concave-convex portions
68 intermediate member
69a, 69b seat part
70 coil spring
71 passage
77 fuel property sensor
81 channel
82 on-off valve
83 fluid tanks
91 pressure sensor

1-10. (canceled)

11. A combustion pressure control system of an internal combustion engine having a plurality of combustion chambers and sub chambers which are communicated with those combustion chambers, the combustion pressure control system is provided with
spring devices each of which has elasticity and is formed to contract, which has one side in the contraction direction which is connected to a sub chamber which is communicated with one combustion chamber, and which has the other side opposite to the one side in the contraction direction which is connected to a sub chamber which is communicated with the other combustion chamber, wherein
the spring device is formed so as to contract while using a pressure change of the combustion chambers as a drive source when the pressures of combustion chambers reach a predetermined control pressure, and
when at least one of the one combustion chamber and the other combustion chamber reaches the control pressure in the time period from a compression stroke to a expansion stroke of combustion cycle, the spring device contracts, whereby volumes of the sub chambers increase and pressure rise of the combustion chambers is suppressed.

12. A combustion pressure control system as set forth in claim 11, wherein in the time period where the pressure of the one combustion chamber which is connected to the spring device reaches the control pressure, the pressure of the other combustion chamber is less than the control pressure.

13. A combustion pressure control system as set forth in claim 12, wherein when the one combustion chamber which is connected to the spring device is in a compression stroke, the other combustion chamber is in an intake stroke or an exhaust stroke.

14. A combustion pressure control system as set forth in claim 11, wherein the spring device include a fluid spring which is filled inside it with a compressible fluid.

15. A combustion pressure control system as set forth in claim 14, further provided with
an operating state detecting device which detects an operating state of the internal combustion engine,
a fluid storage part which is connected to an inside space of the fluid spring and stores fluid, and
a volume adjusting device which changes a volume of the fluid storage part, wherein
the system detects the operating state of the internal combustion engine, selects a maximum pressure of the combustion chambers in accordance with a detected operating state, and uses a selected maximum pressure of the combustion chambers as the basis to change a volume of the fluid storage part.

16. A combustion pressure control system as set forth in claim 15, wherein the volume adjusting device increases the volume of the fluid storage part the lower the maximum pressure of the combustion chambers selected in accordance with the operating state.

17. A combustion pressure control system as set forth in claim 14, further provided with
an operating state detecting device which detects an operating state of the internal combustion engine and
a connecting device which connects inside spaces of a plurality of fluid springs, wherein
the system detects the operating state of the internal combustion engine, selects a maximum pressure of the combustion chambers in accordance with a detected operating state, and uses a selected maximum pressure of the combustion chambers as the basis to change the number of the fluid springs which are connected to each other.

18. A combustion pressure control system as set forth in claim 17, wherein the connecting device increases the number of fluid springs which are connected to each other the lower the selected maximum pressure of the combustion chambers.
